(19) United States
(12) Patent Application Publication
(10) Pub. No.: US 2006/0001294 A1
(43) Pub. Date: Jan. 5, 2006

(54) Rocker assembly for vehicles

(76) Inventors: Steven P. Balgaard, Fenton, MI (US); Marcel R. Cannon, Romeo, MI (US)

Correspondence Address: LAURA C. HARGITT;General Motors Corporation, Legal Staff, Mail Code 482-C23-B21, P.O. Box 300, Detroit, MI, 48265-3000, US

(21) Appl. No.: 11/145,883

(22) Filed: Jun. 6, 2005

Related U.S. Application Data
(60) Provisional application No. 60/584,877, filed on Jul. 1, 2004.

(51) Int. Cl. B60R 27/00

(52) U.S. Cl. 296/209

(57) ABSTRACT

A rocker assembly for a vehicle includes a roll formed rocker inner panel adapted to be connected to a vehicle body of the vehicle. The rocker assembly also includes a roll formed rocker outer panel connected to the rocker inner panel to form a closed section.

### CROSS REFERENCE TO RELATED APPLICATION

This application claims the benefit of copending U.S. Provisional Patent Application Ser. No. 60/584,877, filed Jul. 1, 2004.

### TECHNICAL FIELD

The present invention relates generally to vehicles and, more particularly, to a rocker assembly for a vehicle.

### BACKGROUND OF THE INVENTION

It is known to provide a vehicle such as a pick-up truck with a vehicle body having a door opening. It is also known to provide at least one door pivotally connected to the body to open and close the door opening. Typically, the door is pivotally mounted on a vertical pillar through hinges. The door has an inner panel and outer panel which are joined together to form a space therebetween.

It is also known to provide a rocker in the vehicle body of the vehicle to form a lower portion of the door opening. However, these rockers have encountered large column loads as a result of front offset barrier loads. To increase the strength of the rockers, additional reinforcements have to be added, thereby increasing mass and cost.

Therefore, it is desirable to provide a rocker assembly for a vehicle that has increased strength. It is also desirable to provide a rocker assembly for a vehicle that has a closed or continuous section. It is further desirable to provide a rocker assembly for a vehicle that has reduced cost and mass. Thus, there is a need in the art to provide a rocker assembly for a vehicle that meets these desires.

### SUMMARY OF THE INVENTION

It is, therefore, one object of the present invention to provide a new rocker assembly for a vehicle.

It is another object of the present invention to provide a rocker assembly for a vehicle that has increased strength.

To achieve the foregoing objects, the present invention is a rocker assembly for a vehicle. The rocker assembly includes a roll formed rocker inner panel adapted to be connected to a vehicle body of the vehicle. The rocker assembly also includes a roll formed rocker outer panel connected to the rocker inner panel to form a closed section.

One advantage of the present invention is that a new rocker assembly is provided for a vehicle. Another advantage of the present invention is that the rocker assembly is made using a roll forming process to produce a closed section. Yet another advantage of the present invention is that the rocker assembly has increased strength per unit mass, enabling improvements in impact performance and strength related loading conditions with less material and added parts. Still another advantage of the present invention is that the rocker assembly has reduced cost and mass. A further advantage of the present invention is that rocker assembly improves noise and vibration performance of the vehicle body. Yet a further advantage of the present invention is that the rocker assembly has a continuous section that deals effectively with increased requirements driven by higher speed and raised barrier side impact loading conditions. Still a further advantage of the present invention is that the rocker assembly has a roll formed section, incorporating much higher strengths in a less costly fabrication process with less material scrap.

Other objects, features, and advantages of the present invention will be readily appreciated, as the same becomes better understood, after reading the subsequent description taken in conjunction with the accompanying drawings.

### BRIEF DESCRIPTION OF THE DRAWINGS

FIG. 1 is a perspective view of a vehicle incorporating a rocker assembly, according to the present invention.

FIG. 2 is a partial side elevational view of the vehicle of FIG. 1.

FIG. 3 is a sectional view taken along line 3-3 of FIG. 2.

### DESCRIPTION OF THE PREFERRED EMBODIMENT

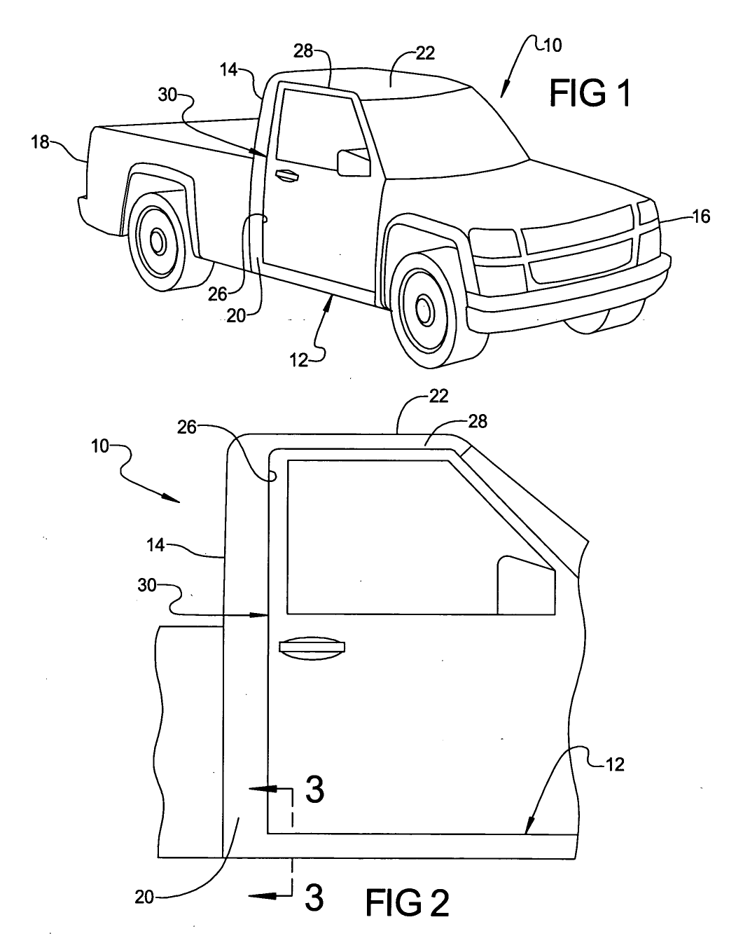

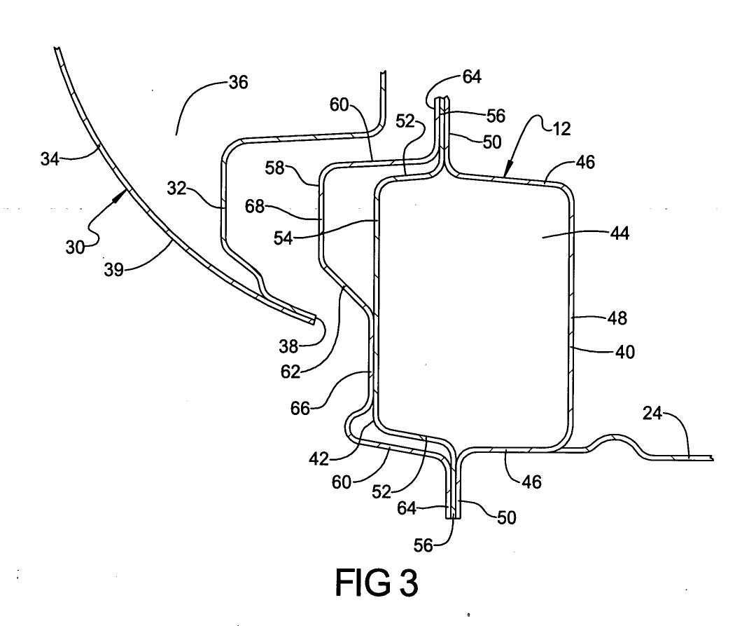

Referring to the drawings and in particular FIGS. 1 and 2, one embodiment of a vehicle 10, such as a motor vehicle, is shown incorporating a rocker assembly, generally indicated at 12 and according to the present invention. The vehicle 10 includes a vehicle body 14 having a forward end 16, a rear end 18, and a pair of sides 20 (one shown) spaced laterally and extending longitudinally between the forward end 16 and the rear end 18. The vehicle body 14 also includes a roof 22 and a floor 24 (FIG. 3) attached to the sides 20 to form an occupant compartment therein.

The vehicle body 14 also includes an aperture or door opening 26 formed through its side 20. The vehicle body 14 includes a roof rail 28, forming a top portion of the door opening 26. The vehicle body 14 also includes the rocker assembly 12 forming a lower portion of the door opening 26. It should be appreciated that vertical pillars form side portions of the door opening 26. It should also be appreciated that the door opening 26 is a continuous aperture extending longitudinally between the vertical pillars and vertically between the roof rail 28 and the rocker assembly 12.

The vehicle 10 also includes a side door, generally indicated at 30, disposed in and closing the door opening 26. The side door 30 faces rearward or toward the rear end 18 of the vehicle body 14 and may be attached at its forward end to the forward vertical pillar. It should be appreciated that the side door 30 is hinged with pivot hinges (not shown) to the forward vertical pillar to allow the side door 30 to swing outward and forward with respect to the forward end 16 of the vehicle 10. It should also be appreciated that the vehicle 10 further includes a latch (not shown) or latch member (not shown) attached to a rear of the side door 30 for engagement and disengagement with a latch member (not shown) or latch (not shown) on the rear vertical pillar of the vehicle body 14. It should further be appreciated that the pivot hinges, latch member, and latch are conventional and known in the art.

Referring to FIG. 3, the side door 30 includes a door inner panel 32 and a door outer panel 34 joined to the door inner panel 32 and forming a space 36 therebetween. The door inner panel 32 and door outer panel 34 are joined together by a hem flange to form a bottom marginal lip or edge 38 at a lower end thereof. The side door 30 also includes a lower portion 39 that extends downwardly to overlap a portion of the rocker assembly 12. It should be appreciated that the side door 30 is conventional and known in the art.

The rocker assembly 12, according to the present invention, is a box section having a rocker inner panel 40 and a rocker outer panel 42 joined to the rocker inner panel 40 to form a space 44 therebetween. It should be appreciated that a portion of the rocker inner panel 40 overlaps and is secured to a portion of the floor 24 by a suitable mechanism such as welding.

The rocker inner panel 40 is roll formed, for example, as a hat member including two lateral sides 46 extending longitudinally and a web 48 therebetween extending vertically and longitudinally. The web 48 and sides 46 define a generally U-shaped cross-section. The rocker inner panel 40 also includes marginal flanges 50 extending vertically and longitudinally from the sides 46 and generally parallel to the web 48 to form a generally inverted “hat” shaped section or configuration. The rocker inner panel 40 is made of an ultra high strength material, for example, a metal material. The rocker inner panel 40 is formed by a roll forming process. The rocker inner panel 40 is a monolithic structure being integral, unitary, and one-piece. It should also be appreciated that the rocker inner 40, could have added features protruding in or out of the section.

The rocker outer panel 42 is formed, for example, as a hat member including two lateral sides 52 extending longitudinally and a web 54 therebetween extending vertically and longitudinally. The web 54 and sides 52 define a generally U-shaped cross-section. The rocker outer panel 42 also includes marginal flanges 56 extending vertically and longitudinally from the sides 52 and generally parallel to the web 54 to form a generally inverted “hat” shaped section or configuration. The rocker outer panel 42 is made of an ultra high strength material, for example, a metal material. The rocker outer panel 42 is formed by a roll forming process. The rocker outer panel 42 is a monolithic structure being integral, unitary, and one-piece. It should be also appreciated that the rocker outer panel 42, could have added features protruding in or out of the section.

Referring to FIG. 3, the rocker outer panel 42 is disposed in abutting relationship with the rocker inner panel 40. The rocker outer panel 42 is fixedly secured to the rocker inner panel 40. More specifically, the flanges 56 of the rocker outer panel 42 are welded to the flanges 50 of the rocker inner panel 40 at predetermined points along the longitudinal expanse thereof. It should be appreciated that the flanges 50 and 56 may be bonded together.

The rocker assembly 12 further includes a body side outer panel 58 covering or closing the rocker outer panel 42. In one embodiment, the body side outer panel 58 is formed, for example, as a hat member including two lateral sides 60 extending longitudinally and a web 62 therebetween extending vertically and longitudinally. The web 62 and sides 60 define a generally U-shaped cross-section. The body side outer panel 58 may also include marginal flanges 64 extending vertically and longitudinally from the sides 60 and generally parallel to the web 62 to form a generally inverted “hat” shaped section or configuration. The web 62 may include a rib portion 66 extending laterally inward and/or a rib portion 66 extending laterally outward. The body side outer panel 58 is generally made of a metal material. The body side outer panel 58 is a monolithic structure being integral, unitary, and one-piece. The flanges 64 of the body side outer panel 58 are disposed in abutting relationship with the flanges 56 of the rocker outer panel 42. The body side outer panel 58 is secured to the rocker outer panel 42 by suitable means such as welding the flanges 64 of the body side outer panel 58 to the flanges 56 of the rocker outer panel 42 at predetermined points along the longitudinal expanse thereof. It should be appreciated that the flanges 64 and 56 could be bonded together. It should also be appreciated that the flanges 50, 56, and 64 could have an orientation other than vertical such as angled or horizontal. It should also be appreciated that the body side outer panel 58 could be secured to the rocker outer panel 42 at locations other than the rocker outer flanges 56.

Accordingly, the rocker assembly 12 provides the combination of a roll forming process and ultra high strength material to produce a closed section comprised of two roll formed hat shaped sections incorporated into the rocker section of the vehicle body 14. The combination of the lower cost forming process and ultra high strength materials results in a rocker assembly 12, which minimizes investment, maximizes strength per unit mass, and results in a lighter, lower cost, and significantly higher strength structural member. Because the rocker assembly 12 is roll formed, much higher strengths can be incorporated in a less costly fabrication process with less material scrap.

The present invention has been described in an illustrative manner. It is to be understood that the terminology, which has been used, is intended to be in the nature of words of description rather than of limitation.

Many modifications and variations of the present invention are possible in light of the above teachings. Therefore, within the scope of the appended claims, the present invention may be practiced other than as specifically described.

1. A rocker assembly for a vehicle comprising:
a roll formed rocker inner panel adapted to be connected to a vehicle body of the vehicle; and
a roll formed rocker outer panel connected to said rocker inner panel to form a closed section.

2. A rocker assembly as set forth in claim 1 wherein said rocker inner panel has a generally top hat cross-sectional shape.

3. A rocker assembly as set forth in claim 1 wherein said rocker outer panel has a generally top hat cross-sectional shape.

4. A rocker assembly as set forth in claim 1 wherein said rocker inner panel is made of an ultra high strength material.

5. A rocker assembly as set forth in claim 1 wherein said rocker outer panel is made of an ultra high strength material.

6. A rocker assembly as set forth in claim 1 wherein said rocker inner panel comprises a web, a pair of opposed sides extending generally perpendicular from said web, and a pair of flanges, one of said flanges extending generally perpendicular from one of said sides.

7. A rocker assembly as set forth in claim 1 wherein said rocker outer panel comprises a web, a pair of opposed sides extending generally perpendicular from said web, and a pair of flanges, one of said flanges extending generally perpendicular from one of said sides.

8. A rocker assembly as set forth in claim 1 wherein said rocker inner panel is a monolithic structure being integral, unitary, and one-piece.

9. A rocker assembly as set forth in claim 1 wherein said rocker outer panel is a monolithic structure being integral, unitary, and one-piece.

10. A rocker assembly as set forth in claim 1 including a plurality of welds to join flanges of said rocker inner panel and flanges of said rocker outer panel together.

11. A rocker assembly as set forth in claim 1 including a body side outer panel covering said rocker outer panel.

12. A rocker assembly as set forth in claim 11 wherein said body side outer panel has a generally top hat cross-sectional shape.

13. A rocker assembly as set forth in claim 11 wherein said body side outer panel comprises a web, a pair of opposed sides extending generally perpendicular from said web, and a pair of flanges, one of said flanges extending generally perpendicular from one of said sides.

14. A rocker assembly as set forth in claim 11 wherein said body side outer panel is a monolithic structure being integral, unitary, and one-piece.

15. A rocker assembly as set forth in claim 11 including a plurality of welds to join flanges of said body side outer panel and flanges of said rocker outer panel together.

16. A vehicle comprising:
a vehicle body having an opening formed through a side thereof;
a roof rail forming a top portion of said opening;
a rocker assembly forming a bottom portion of said opening; and
said rocker assembly comprising a roll formed rocker inner panel connected to said vehicle body and a roll formed rocker outer panel connected to said rocker inner panel to form a closed section.

17. A vehicle as set forth in claim 16 wherein said rocker inner panel has a generally top hat cross-sectional shape.

18. A vehicle as set forth in claim 16 wherein said rocker outer panel has a generally top hat cross-sectional shape.

19. A vehicle as set forth in claim 16 wherein said rocker inner panel is made of an ultra high strength material.

20. A vehicle as set forth in claim 16 wherein said rocker outer panel is made of an ultra high strength material.

21. A vehicle as set forth in claim 16 wherein said rocker inner panel comprises a web, a pair of opposed sides extending generally perpendicular from said web, and a pair of flanges, one of said flanges extending generally perpendicular from one of said sides.

22. A vehicle as set forth in claim 16 wherein said rocker outer panel comprises a web, a pair of opposed sides extending generally perpendicular from said web, and a pair of flanges, one of said flanges extending generally perpendicular from one of said sides.

23. A vehicle as set forth in claim 16 wherein said rocker inner panel is a monolithic structure being integral, unitary, and one-piece.

24. A vehicle as set forth in claim 16 wherein said rocker outer panel is a monolithic structure being integral, unitary, and one-piece.

25. A vehicle as set forth in claim 16 including a plurality of welds to join flanges of said rocker inner panel and flanges of said rocker outer panel together.

26. A vehicle as set forth in claim 16 including a body side outer panel covering said rocker outer panel.

27. A vehicle as set forth in claim 26 wherein said body side outer panel has a generally top hat cross-sectional shape.

28. A vehicle as set forth in claim 26 wherein said body side outer panel is made of a metal material.

29. A vehicle as set forth in claim 26 wherein said body side outer panel comprises a web, a pair of opposed sides extending generally perpendicular from said web, and a pair of flanges, one of said flanges extending generally perpendicular from one of said sides.

30. A vehicle as set forth in claim 26 wherein said body side outer panel is a monolithic structure being integral, unitary, and one-piece.

31. A vehicle as set forth in claim 26 including a plurality of welds to join flanges of said body side outer panel and flanges of said rocker outer panel together.

32. A rocker assembly for a vehicle comprising:
a roll formed rocker inner panel adapted to be connected to a vehicle body of the vehicle;
said rocker inner panel comprising a web, a pair of opposed sides extending from said web, and a pair of flanges, one of said flanges extending from one of said sides, said rocker inner panel being a monolithic structure being integral, unitary, and one-piece;
a roll formed rocker outer panel connected to said rocker inner panel to form a closed section;
said rocker outer panel comprising a web, a pair of opposed sides extending from said web, and a pair of flanges, one of said flanges extending from one of said sides, said rocker outer panel being a monolithic structure being integral, unitary, and one-piece;
a body side outer panel covering said rocker outer panel, said body side outer panel comprising a web, a pair of opposed sides extending from said web, and a pair of flanges, one of said flanges extending from one of said sides, said body side outer panel being a monolithic structure being integral, unitary, and one-piece; and
a plurality of welds to join said flanges of said body side outer panel and said flanges of said rocker outer panel and said flanges of said rocker inner panel together.
